(19) United States
(12) Patent Application Publication
(10) Pub. No.: US 2007/0285273 A1
(43) Pub. Date: Dec. 13, 2007

(54) Information playback apparatus

(76) Inventor: Koichi Kobayashi, Tachikawa-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/731,059

(22) Filed: Mar. 30, 2007

(30) Foreign Application Priority Data
Mar. 31, 2006 (JP) 2006-100549

(51) Int. Cl. G08C 19/00

(52) U.S. Cl. 340/825.72; 340/825.25; 343/702; 455/90.3; 361/683

(57) ABSTRACT

According to one embodiment, in a portable information equipment provided with a wireless communication unit, the surface of a control unit having switches for operating the portable information equipment and the area around the control unit are made of nonmetallic material, and an antenna for wireless communication is incorporated in the nonmetallic material part of the control unit. A radio wave is efficiently emitted from the antenna, and a receiving performance is improved, even when a metal is used for an outer case.

### CROSS-REFERENCE TO RELATED APPLICATIONS

This application is based upon and claims the benefit of priority from Japanese Patent Application No. 2006-100549, filed Mar. 31, 2006, the entire contents of which are incorporated herein by reference.

### BACKGROUND

1. Field

One embodiment of the invention relates to a portable information equipment having a communication unit for wireless data transfer with an optional circuit unit.

2. Description of the Related Art

A portable information equipment, typically a portable audio player has now been widely used.

A portable audio player is required to have a wireless communication with optional electronic equipment under specified conditions in a closed network at home and office. For wireless communication suitable for such a closed network, a known wireless LAN or Bluetooth (registered trademark) disclosed already is preferable.

A metallic housing is used in most portable audio players to make size and weight smaller while keeping rigidity. An outer case (housing) may have metallic coating to improve a texture of the case.

However, as metallic material does not transmit a radio wave, resin material is widely used for a part of housing to contain an antenna unit used for wireless communication, or an area close to that part.

For example, Japanese Patent Application Publication (KOKAI) No. 2005-244824 discloses an example of inserting an antenna in a cord member connected to a portable information equipment, in order to separate an antenna unit from an outer case (housing).

However, if resin is used for a part of housing to contain an antenna unit, or an area close to that part, it is necessary to separately manage a housing used for information equipment with a wireless communication function and a housing used for information equipment without a wireless communication function. This increases the management cost.

Further, if a part of housing is made of resin, color and texture become different in a metallic part and a nonmetallic (resin) part. Use of the same material is demanded also from the viewpoint of the housing design. Use of metal and resin in a housing has an influence on the housing design.

The technique disclosed in the Japanese Patent Application Publication (KOKAI) No. 2005-244824 does not intend to provide a housing having a metallic part and a nonmetallic part. Therefore, this does not solve the above-mentioned problem.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A is an exemplary diagram showing an example of information equipment according to an embodiment of the invention;

FIGS. 1B and 1C are exemplary diagrams showing examples of connection between an antenna and a wireless communication unit incorporated in the information equipment shown in FIG. 1A;

FIG. 2 is an exemplary diagram showing a control unit of the information equipment shown in FIG. 1A;

FIG. 3 is an exemplary diagram showing an antenna unit in the control unit of the information equipment shown in FIG. 2;

FIG. 4 is an exemplary diagram showing a metallic material prohibition area in the control unit of the information equipment shown in FIG. 1A;

FIGS. 5A to 5C are exemplary diagrams each showing an example of a direction of radio wave emission (a radio wave emission pattern) of the antenna unit in the control unit of the information equipment shown in FIG. 1A;

FIG. 6 is an exemplary diagram showing another embodiment of an information equipment shown in FIG. 1A according to the invention;

FIG. 7 is an exemplary diagram showing an example of an antenna unit in a control unit of the information equipment shown in FIG. 6;

FIG. 8 is an exemplary diagram showing an example of a direction of radio wave emission (a radio wave emission pattern) of the antenna unit in the control unit of the information equipment shown in FIG. 6;

FIG. 9 is an exemplary diagram showing the distance between a dielectric (user/operator's hand) and the antenna unit in the control unit of the information equipment shown in FIG. 6;

FIG. 10 is an exemplary diagram showing an example of a direction of radio wave emission (a radio wave emission pattern) of the antenna unit in the control unit of the information equipment shown in FIG. 6, when an antenna is provided at a different position on a frame;

FIG. 11 is an exemplary diagram showing an example of a direction of radio wave emission (a radio wave emission pattern) of the antenna unit in the control unit of the information equipment shown in FIG. 6, when an antenna is provided at a different position on a frame;

FIG. 12 is an exemplary diagram showing an example of a direction of radio wave emission (a radio wave emission pattern) of the antenna unit in the control unit of the information equipment shown in FIG. 6, when an antenna is provided at a different position on a frame;

FIG. 13 is an exemplary diagram showing an example of a direction of radio wave emission (a radio wave emission pattern) of the antenna unit in the control unit of the information equipment shown in FIG. 6, when an antenna is provided at a different position on a frame;

FIG. 14 is an exemplary diagram showing an example of a direction of radio wave emission (a radio wave emission pattern) of the antenna unit in the control unit of the information equipment shown in FIG. 6, when an antenna is provided at a different position on a frame;

FIG. 15 is an exemplary diagram showing an example of a direction of radio wave emission (a radio wave emission pattern) of the antenna unit in the control unit of the information equipment shown in FIG. 6, when an antenna is provided at a different position on a frame;

FIG. 16A is an exemplary diagram showing another embodiment of an information equipment shown in FIG. 1A according to the invention;

FIG. 16B is an enlarged view of an antenna unit in a control unit of the information equipment shown in FIG. 16A;

FIG. 17 is an exemplary diagram showing an example of the antenna unit in the control unit of the information equipment shown in FIGS. 16A and 16B;

FIG. 18 is an exemplary diagram showing an example of the antenna unit in the control unit of the information equipment shown in FIGS. 16A and 16B;

FIG. 19 is an exemplary diagram showing an example of a direction of radio wave emission (a radio wave emission pattern) of the antenna unit in the control unit of the information equipment shown in FIGS. 16A and 16B;

FIG. 20 is an exemplary diagram showing another embodiment of an information equipment shown in FIG. 1A according to the invention;

FIG. 21 is an exemplary diagram showing an example of an antenna unit in a control unit of the information equipment shown in FIG. 20; and

FIG. 22 is an exemplary diagram showing an example of a direction of radio wave emission (a radio wave emission pattern) of the antenna unit in the control unit of the information equipment shown in FIG. 20.

### DETAILED DESCRIPTION

Various embodiments according to the invention will be described hereinafter with reference to the accompanying drawings. In general, according to one embodiment of the invention, an information equipment comprising: a control unit which is made of nonmetallic material, and operated by the user; a display unit to display an image; a metallic housing which is made of metallic material, and covers the control unit and a part other than the control unit; and an antenna unit to emit a radio wave through the control unit.

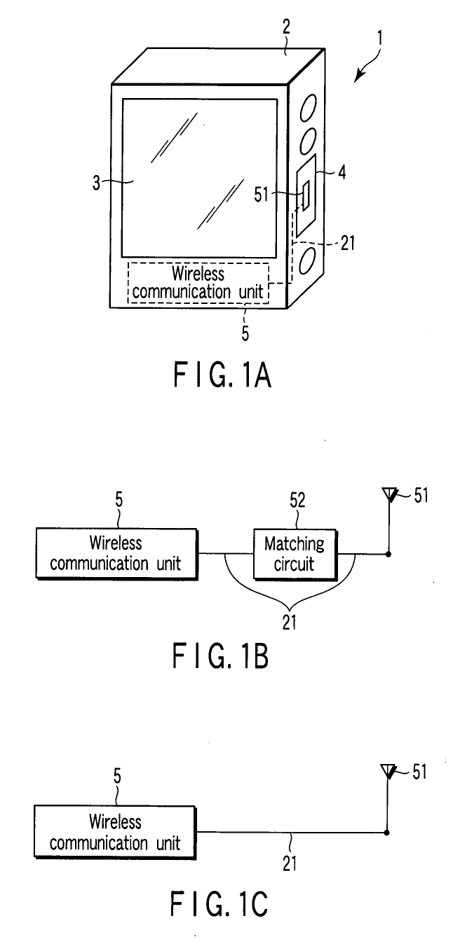

According to an embodiment, FIG. 1A shows an audio player as an example of a portable information equipment.

As shown in FIG. 1A, an audio player 1 is like a rectangular box made of metallic material such as aluminum. The audio player 1 has a substantially rectangular or cubic housing 2, and contains a display unit in at least one side to display an image file or a menu screen related to a tune or a tune title under playing. The display unit 3 is a LCD (Liquid Crystal Display), for example.

The audio player includes a memory (a circuit unit) to hold musical data, sound data and related image data, a digital/analog (D/A) converter (a circuit unit) to convert musical data and sound data held in the memory into audible signals, an analog/digital (A/D) converter (a circuit unit) to convert musical data and sound data to be held in the memory into digital signals, a display control unit (a circuit unit, or a host unit) to display character information and image data in the display unit 3, and a wireless communication unit 5 diagrammatically shown in FIGS. 1B and 1C. The audio player 1 is also provided with a connector or an interface used for input/output of musical data, sound data and image data.

A control unit 4 for operating the audio player 1 is provided on an optional side or in a part of an optional side of the housing 2, for input/output of musical data, audio data and image data, and input of (operation instruction) for playback and stop of various data held in the memory. Unlike the main part of the housing 2, the main part of the control unit 4 is made of nonmetallic material, for example, resign material (a wave non-shielding member).

In a predetermined part of the housing 2, a wireless communication unit (a circuit unit) 5 is provided. The wireless communication unit conforms to the communication standards of Bluetooth (registered trademark) and wireless LAN, and enables communication with an optional electronic equipment provided in a closed network at home or office.

The wireless communication unit (circuit unit) 5 is connected to the memory, D/A converter, A/D converter and display control unit (host unit), or at least one circuit unit. The wireless communication unit is also connected to an antenna 51 through a matching circuit 52, as shown in FIG. 1B. The wireless communication unit 5 may be connected to the antenna 51 through a wire strip line 21 (a feeder line). The wire strip line (feeder line) 21 is usually given an impedance of 50Ω.

In a predetermined part of the control unit 4, there are provided a power ON/OFF button 41 to operate the audio player 1, a “−” volume button 42-1 and a “+” volume button 42-2 to adjust the volume of a tune under playing, a menu button 43 to input a signal to display and set a menu, and a function selector button 44 to input a command to start/finish communication with an optional electronic equipment through the wireless unit 5. These buttons of the control unit 4 are made of nonmetallic material, such as silicon resin and plastic, considering the user's (operator's) operability and insulation.

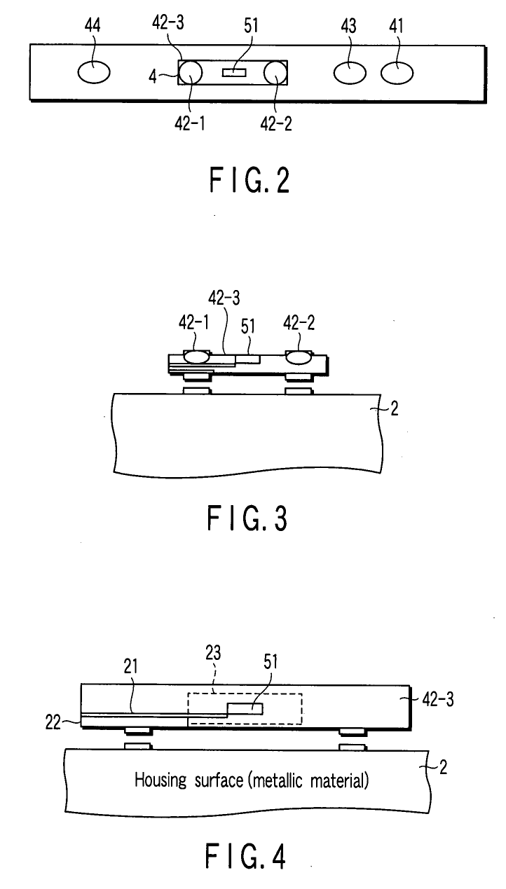

In a predetermined part of the control unit 4, a chip antenna (antenna unit) 51 is provided, which can efficiently transmit a signal output from the wireless communication unit 5, or a radio wave emitted to the outside, and receive a signal input to the wireless communication unit 5, or a radio wave received from the outside. The chip antenna 51 is a multilayer chip antenna, and about 2 mm square when used for a band of 2.4 GHz. In the example shown in FIG. 2, the antenna unit (chip antenna) 51 is buried in a space between the “”” volume button 42-1 and the “+” volume button 42-2 of the control unit 4.

As shown in FIG. 3, a volume pad 42-3 including two buttons 42-1 and 42-2 is usually constructed to expose a nonmetallic material, such as relatively large resin or rubber, and does not absorb a radio wave to be transmitted from or received by the antenna unit 51.

FIG. 4 shows the structure that the antenna unit 51 is provided in the volume pad 42-3 shown in FIG. 3.

As shown in FIG. 4, a wiring pattern (a wire strip line or a feeder line), placed between the housing 2 and control unit 4 for connecting the antenna unit 51 and wireless communication unit 5, and a GND (grounding) pattern 22 are positioned to have a maximum distance to the antenna unit 51 in the area around the antenna unit 51. Namely, around the area of the control unit 4 where the antenna unit 51 is placed, there is defined a metallic material prohibition area 23 where the wire strip line 21 and GND pattern 22 must not be arranged.

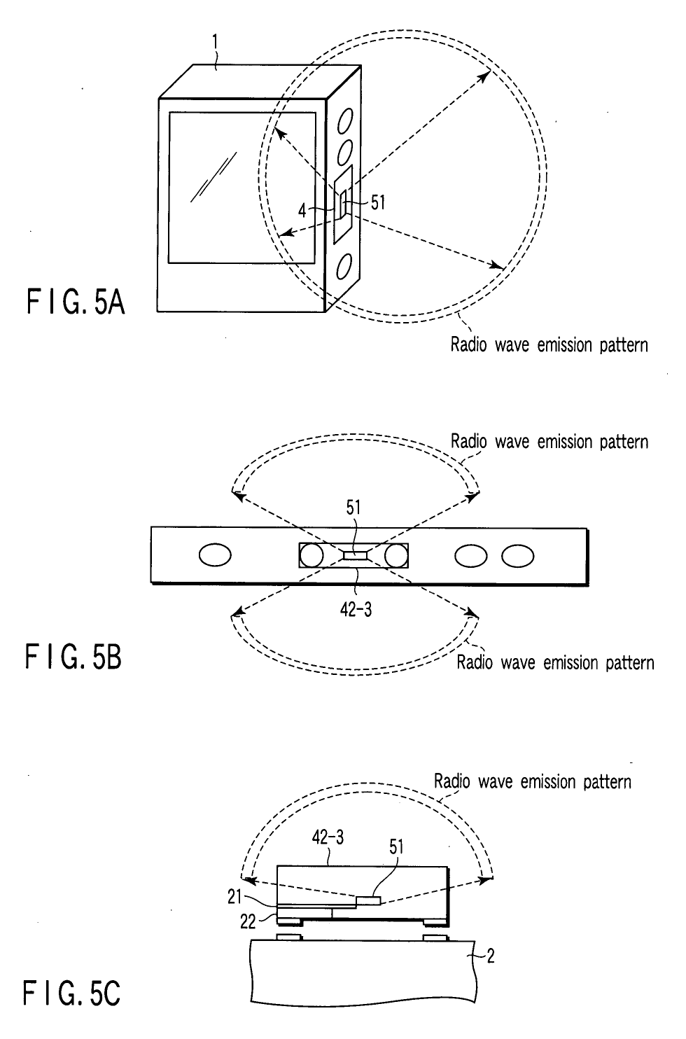

As the antenna unit 51 is provided on the end face of the volume pad 42-3 of the control unit 4 as explained in FIGS. 1A, 2 to 4, an emitted radio wave can be largely diffused as shown in FIGS. 5A to 5C. FIG. 5A shows the state that a radio wave is emitted from the control unit 4, or the end face of the volume pad 42-3. FIGS. 5B and 5C show the state that an emitted radio wave is diffused in the direction parallel to the thickness of the housing 2, when viewing from the end face of the control unit 4.

As seen from FIGS. 5A to 5C, a radio wave output from the wireless communication unit 5 and emitted through the antenna unit 51 in a transmission mode is efficiently emitted to the outside of the housing 2 while suppressing the element going back to the inside of the audio player 1. By the arrangement of the antenna unit 51 as explained in FIGS. 1A, 2 to 4, a radio wave can be efficiently received in a receiving mode.

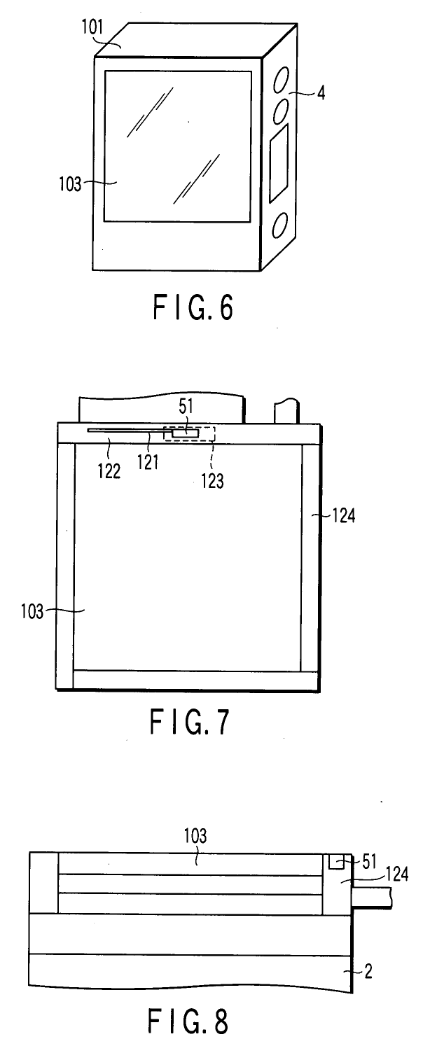

FIG. 6 shows another arrangement of the antenna unit shown in FIGS. 1A, 1B, 1C, 2 to 4. The same elements as those explained in FIGS. 1A, 1B, 1C, 2 to 4 are given the same reference numerals, and detailed explanation will be omitted.

An audio player 101 shown in FIG. 6 has a metallic housing 2 covering the area around a display unit 103. The antenna unit 51 is provided in a predetermined area around the display unit 103.

The display unit 103 mostly employs an LCD panel (LCD substrate) and an illumination substrate or an organic EL panel. As the housing 2 slightly covers the peripheral edge of the LCD panel and illumination substrate or organic EL panel, the antenna 51 can be placed at the end face of the housing 2, or at a predetermined position in the horizontal direction of the display unit 103, or at a position substantially the border between the housing 2 and display unit 103, by cutting off the housing 2 a little.

As the housing 2 is generally provided in a resin frame 124, which supports the LCD panel and illumination substrate or an organic EL (electroluminescence) panel, the antenna unit 51 may be placed at a predetermined position on the frame 124 as shown in FIG. 7.

A wiring pattern (wire strip line) 121 for connecting the antenna unit 51 and wireless communication unit 5, and a GND (grounding) pattern 122 are positioned to have a maximum distance to the antenna unit 51 on the frame 124 around the antenna unit 51, as shown in FIG. 8. Namely, in the area around the antenna unit 51 on the frame 124, a metallic material prohibition area 123 where the wire strip line 121 and GND pattern 122 must not be arranged is defined.

As shown in FIGS. 6 and 7, the antenna unit 51 provided on the frame 124 that is at the end face of the housing 2 can provide a preferable emission of radio wave irrespectively of the user's hand position when holding the player 1.

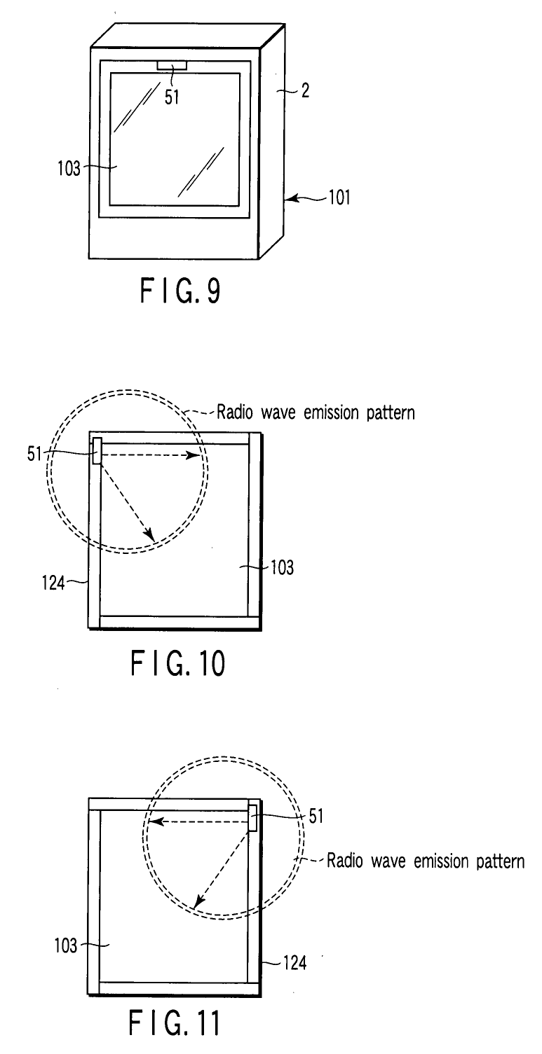

The user mostly holds the side of the housing 2 so that he can see the display unit 103 substantially from the horizontal direction, as shown in FIG. 9. In this case, the antenna 51 is placed at the position relatively separated from the user's (operator's) hand, that is, a dielectric. Therefore, a radio wave emitted from the antenna 51 is prevented from undesirably absorbing by the user's hand, or a dielectric.

Even if the user holds the player 1 by holding the rear side of the player by the palm and grasping the side of the housing 2, the antenna unit 51 is still relatively far from the user's hand, and is hardly influenced by the user's hand.

FIGS. 10 to 14, 15A, 15B and 15C show directions of a radio wave emitted from the antenna unit, when the antenna unit is provided at an optional position on the frame different from the position shown in FIGS. 6 and 7.

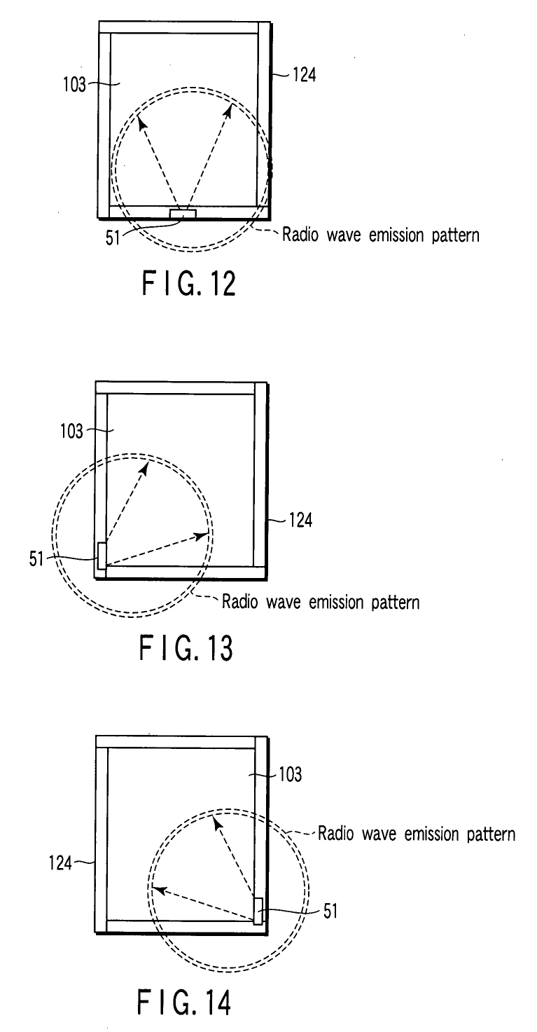

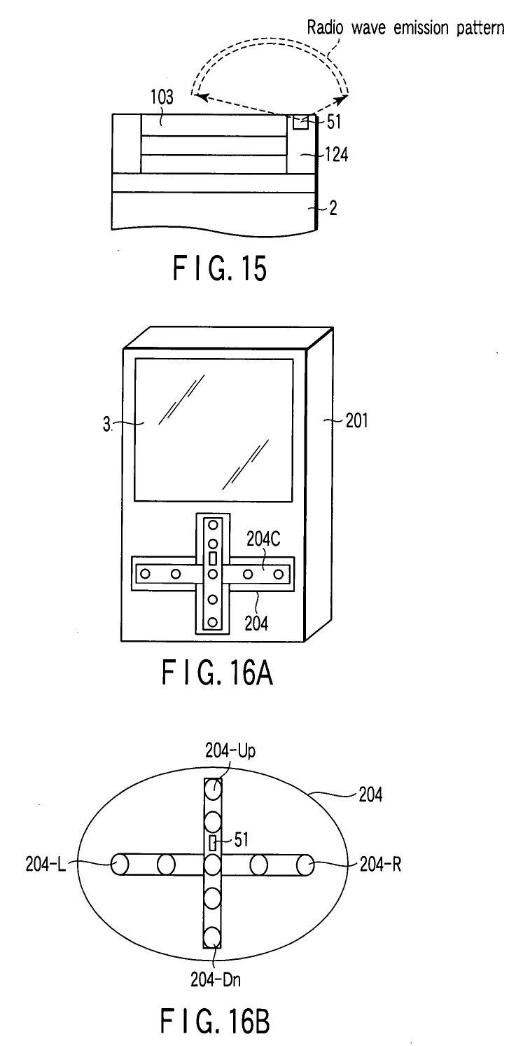

For example, as shown in FIGS. 10 to 14, when the antenna unit 51 is provided at a corner where optional two sides of the frame 124 are joined, a radio wave is emitted in the direction from the corner to the display surface of the display unit 103. As for the cross-sectional direction of the display unit 103, a radio wave is emitted in the direction from the display surface to the outside of the housing 2, as shown in FIGS. 15A to 15C. Further, as shown in FIG. 12, even if the antenna unit 51 is provided close to the center of optional one side of the frame (substantially similar to the position shown in FIG. 6), a radio wave emitted from the antenna unit 51 advances in the direction toward the display surface of the display unit 103.

FIGS. 16A and 16B show still another arrangement of the antenna unit shown in FIGS. 1A, 2 to 4. The same elements as those explained in FIGS. 1A, 2 to 4 are given the same reference numerals, and detailed explanation will be omitted.

An audio player 201 shown in FIG. 16A has a metallic housing 2, a display unit 3 provided in a predetermined part of the housing 2, and a control unit 204 formed on substantially the same plane as the display unit 3 by cutting off a part of the housing 2 in an optional shape.

The control unit 204 has buttons arranged in four directions like a cross, and a nonmetallic cover member 204C covering the buttons. Each button is enclosed by the housing 2 and cover member 204C.

Direction buttons, for example, a LEFT button 204-L and a RIGHT button 204-R, are given a function of a “−” volume button and a function of a “+” volume button, respectively, shown as an example in FIG. 2.

An UP button 204-Up and a DOWN button 204-Dn are used for searching a tune to be played and given a function of scrolling a tune title to be displayed in the display unit 3. A button 204-N at the center of the cross is given a function of outputting a command to instruct playback of a tune selected by the buttons 204-Up and 204-Dn.

As shown enlarged in FIG. 16B, each button is covered by the nonmetallic cover member 204C in the control unit 204. Therefore, when the antenna unit 51 is placed at an optional position between the buttons 204-Up and 204-Dn or between the buttons 204-L and 204-R, the wireless communication unit 5 can efficiently transmit a wave and receive a wave with a designated sensitivity.

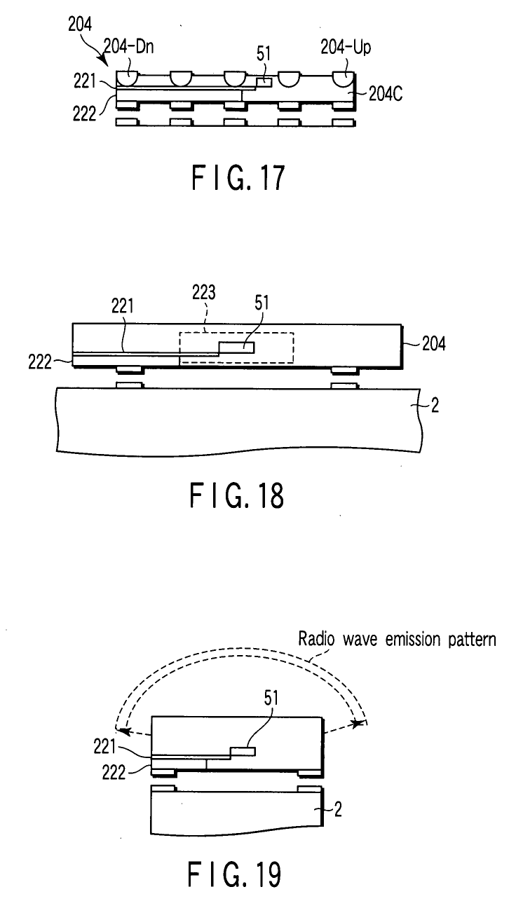

The antenna 51 may be embedded at a specified position of the cover member 204C made of silicon resin, for example, in the control unit 204 (refer to FIG. 16A), as shown in FIG. 17.

Around the antenna unit 51 of the cover member 204C of the control unit 204, a wiring pattern (wire strip line) 221 for connecting the antenna unit 51 and wireless communication unit 5, and a GND (grounding) pattern 222 are arranged to have a maximum distance to the antenna unit 51, as shown in FIG. 18. Therefore, in the predetermined area of the cover member 204C of the control unit 204, or around the area where the antenna unit 51 is placed, a metallic material prohibition area 223 where the wire strip line 221 and GND pattern 222 must not be arranged is defined.

By providing the metallic material prohibition area 223, a radio wave output from the wireless communication unit 5 and emitted through the antenna unit 51 in a transmission mode is efficiently emitted to the outside of the housing 2 while suppressing the element going back to the inside of the audio player 201, as shown in FIG. 19.

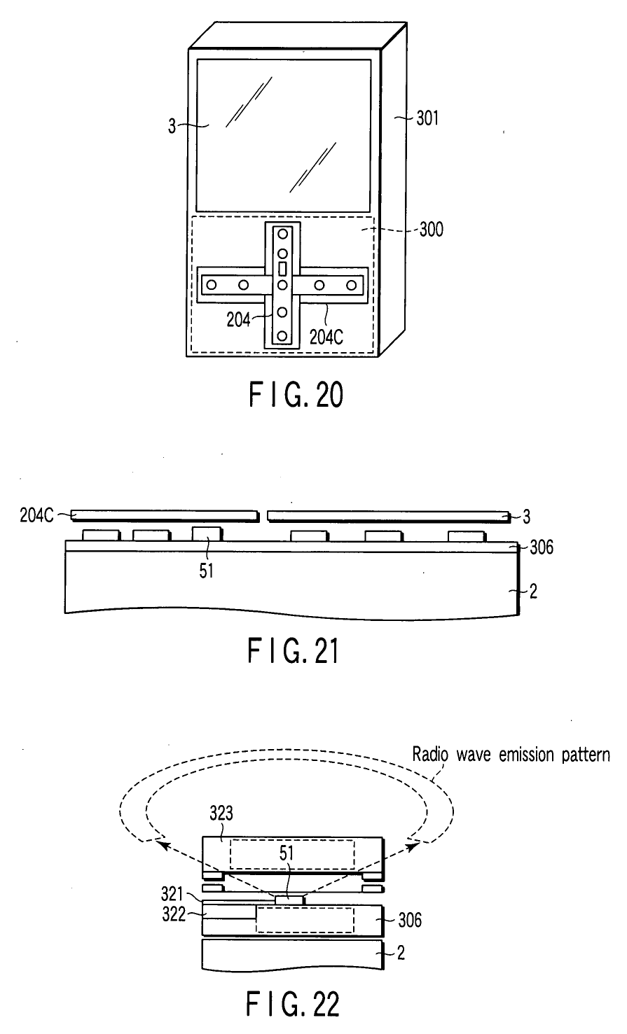

FIG. 20 shows still another arrangement of the antenna unit shown in FIGS. 1A, 2 to 4. The same elements as those explained in FIGS. 1A, 2 to 4 are given the same reference numerals, and detailed explanation will be omitted.

An audio player 301 shown in FIG. 20 has a metallic housing 2, a display unit 3 provided at a predetermined position in the housing 2, and a control unit 304 formed on substantially the same plane as the display unit 3 by cutting off a part of the housing 2 in an optional shape. In the control unit 304, as shown in FIG. 21, a circuit board supporting a driving circuit and backlight (not shown) for displaying characters and images in the display unit 3 is arranged almost all area of the inside of the housing 2.

The control unit 304 has buttons arranged in four directions like a cross, and a nonmetallic cover member 304C covering the buttons. Each button is enclosed by the housing 2 and cover member 304C.

Direction buttons, for example, a LEFT button 304-L and a RIGHT button 304-R, are given a function of a “−” volume button and a function of a “+” volume button, respectively, shown as an example in FIG. 2. An UP button 304-Up and a DOWN button 304-Dn are used for searching a tune to be played and given a function of scrolling a tune title to be displayed in the display unit 3. A button 304-N at the center of the cross is given a function of outputting a command to instruct playback of a tune selected by the buttons 304-Up and 304-Dn.

Inside the cover member 304C of the control unit 304, in a space between circuit board 306 and the cover member 304C, the antenna unit 51 is provided at a predetermined position among circuit components (e.g. IC chip) provided on the circuit board 306, as shown in FIG. 21.

By providing the antenna member 51 on the circuit board 306, as shown in FIG. 21, it is unnecessary to embed the antenna unit 51 in the cover member 304C as in the example shown in FIGS. 16A, 16B and 17. Therefore, an existing part can be used for the cover member 304C, and the part cost can be reduced.

As shown in FIG. 22, as in the other embodiments, in the area around the antenna unit 51 on the circuit board 306, a wiring pattern (wire strip line) 321 for connecting the antenna unit 51 and wireless communication unit 5 and a GND (grounding) pattern 322 are arranged to have a maximum distance to the antenna unit 51.

As for the whole area of the cover member 304C, or the predetermined area in the direction from the circuit board 306 to the outside of the housing 2, a metallic material prohibition area 323 where the wire strip line 321 and GND pattern 322 must not be arranged is defined.

As the metallic material prohibition area 323 is defined in substantially whole area in the direction to the housing 2 when the housing 2 is viewed from the circuit board 306, a radio wave emitted through the antenna unit 51 in a transmission mode is efficiently emitted to the outside of the housing 2 while suppressing the element going back to the inside of the audio player 301. As seen from FIGS. 21 and 22, by providing the antenna unit 51 on the circuit board 306 more inside the housing 2 than the cover member 304C, the cover member 304C is substantially made of resin material only, and the metallic material prohibition area 323 is inevitably defined in the whole area around the cross-like control unit 304. Therefore, although the antenna unit 51 is placed more inside the housing 2 than the cover member 304C, the gain of a radio wave emitted from and received by the antenna unit 51 is equivalent to or higher than that in the other embodiments.

As explained above, according to the present invention, it is unnecessary to prepare additional housing for an antenna unit for wireless communication, when adding a wireless communication function to a portable information equipment. This prevents increase in the cost of the parts of a portable information equipment and the whole equipment cost.

Moreover, an antenna unit, particularly, a chip antenna can be incorporated on the surface or the area close to the surface of a housing in almost electrically exposed. This provides sufficient wave emission efficiency and receiving performance, and prevents increase in the power consumption for wireless communication.

Further, even when a wireless communication function is not provided in the same type information equipment, the parts are common. This prevents increase in the cost of the parts of a portable information equipment and the whole equipment cost.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

In the embodiments explained hereinbefore, an audio player is taken as an example of a portable information equipment. The invention is applicable to a video camera, a fixed information equipment installed in a car, and other various apparatus with a wireless communication function installed in a house.

1. An information equipment comprising:
a control unit which is made of nonmetallic material, and operated by the user;
a display unit to display an image;
a metallic housing which is made of metallic material, and covers the control unit and a part other than the control unit; and
an antenna unit to emit a radio wave through the control unit.

2. The information equipment according to claim 1, wherein the metallic housing which is made of metallic material, contains the control unit, and holds the display unit and control unit with at least a part exposed to the outside.

3. The information equipment according to claim 2, further comprising: a metallic material prohibition area defined in a predetermined area close to the antenna unit, where a feeder line to supply the antenna unit with a signal from the control unit and a GND pattern are not arranged.

4. The information equipment according to claim 2, further comprising:
a feeder line to supply the antenna unit with a signal from the control unit.

5. The information equipment according to claim 4, wherein the feeder line is arranged inside of the metallic housing.

6. The information equipment according to claim 1, wherein the antenna unit which is provided on a frame of the display unit.

7. The information equipment according to claim 6, wherein the antenna unit is provided at a corner of the frame of the display unit.

8. The information equipment according to claim 7, further comprising:
a metallic material prohibition area defined in a predetermined area close to the antenna unit, where a feeder line to supply the antenna unit with a signal from the control unit and a GND pattern are not arranged.

9. The information equipment according to claim 1, wherein the metallic housing which is made of metallic material, holds the circuit unit and display unit with at least a part exposed to the outside, and places a circuit board unit holding a switch unit capable of inputting a control signal used to instruct playback and stop of data held in the circuit unit, in the state covered by a cover member made of nonmetallic material.

10. (canceled)

11. An information equipment comprising:
a case member which is made of metal, and contains a circuit unit in an electrically shielded state; and
an antenna unit holding mechanism which is made of nonmetallic material, and contains the circuit unit in an electrically shielded state by cooperating with the case member, and places an antenna unit to receive a predetermined signal supplied to the circuit unit and transmit an output signal from the circuit unit, in a non-shielded state different from the electrically shielded state.

12. The information equipment according to claim 11, wherein the case member which is made of metallic material, contains the control unit, and holds the display unit and control unit with at least a part exposed to the outside.

13. The information equipment according to claim 12, further comprising: a metallic material prohibition area defined in a predetermined area close to the antenna unit, where a feeder line to supply the antenna unit with a signal from the control unit and a GND pattern are not arranged.

14. The information equipment according to claim 12, further comprising:
a feeder line to supply the antenna unit with a signal from the control unit.

15. The information equipment according to claim 14, wherein the feeder line is arranged inside of the case member.

16. The information equipment according to claim 11, wherein the antenna unit which is provided on a frame of the display unit.

17. The information equipment according to claim 16, wherein the antenna unit is provided at a corner of the frame.

18. The information equipment according to claim 17, further comprising:
a metallic material prohibition area defined in a predetermined area close to the antenna unit, where a feeder line to supply the antenna unit with a signal from the control unit and a GND pattern are not arranged.

19. The information equipment according to claim 11, wherein the case member which is made of metallic material, holds the circuit unit and display unit with at least a part exposed to the outside, and places a circuit board unit holding a switch unit capable of inputting a control signal used to instruct playback and stop of data held in the circuit unit, in the state covered by a cover member made of nonmetallic material.

20. (canceled)
